(19) United States
(12) Patent Application Publication
(10) Pub. No.: US 2014/0344518 A1
(43) Pub. Date: Nov. 20, 2014

(54) APPARATUS AND METHOD FOR PERFORMING DATA TRANSFER BETWEEN STORAGES

(71) Applicant: FUJITSU LIMITED, Kawasaki-shi (JP)

(72) Inventor: Motoyuki KAWABA, Kawasaki (JP)

(73) Assignee: FUJITSU LIMITED, Kawasaki-shi (JP)

(21) Appl. No.: 14/251,998

(22) Filed: Apr. 14, 2014

(30) Foreign Application Priority Data
May 20, 2013 (JP) 2013-106351

(51) Int. Cl. G06F 3/06

(52) U.S. Cl. CPC G06F 3/0655; G06F 3/0689; G06F 3/0619
USPC 711/114

(57) ABSTRACT

An apparatus connected to first and second storages performs data transfer between the first and second storages for a plurality of times with different data sizes, and measures a transfer time defined as a transfer interval time for data transfer of each of the plurality of times. The apparatus identifies a maximum size data indicating a maximum data size for data transfer between the first and second storages, based on the transfer time and the data size for data transfer of each of the plurality of times. When data transfer is performed between the first and second storages, the apparatus divides transfer target data for the data transfer into plural pieces of divided data, based on the maximum size data, and outputs, for each of the plural pieces of divided data, a data transfer request for requesting the apparatus to perform data transfer between the first and second storages.

### CROSS-REFERENCE TO RELATED APPLICATION

This application is based upon and claims the benefit of priority of the prior Japanese Patent Application No. 2013-106351, filed on May 20, 2013, the entire contents of which are incorporated herein by reference.

### FIELD

The embodiments discussed herein are related to apparatus and method for performing data transfer between storages.

### BACKGROUND

In recent years, there has been an increase in the amount of data processed by information processing apparatuses, such as a computer. Nowadays, it has become common for an information processing apparatus to process a larger amount of data than before. As a result, a hierarchical storage system, which makes it possible to higher access than before while suppressing data storage cost, has been adopted in many cases.

In storage, storage cost per unit amount of data tends to increase as an access speed increases. Accordingly, in tiered storage with two kinds of storages having different access speeds, all the data is stored in an inexpensive storage having a lower access speed, and part of data that is thought to be frequently used is stored in an expensive storage having a higher access speed. By using an inexpensive low-speed storage or an expensive high-speed storage depending on circumstances, it becomes possible to perform high speed access while suppressing data storage cost.

In tiered storage, data transfer is performed between storages as occasion arises. Data transfer between storages is performed by an information processing apparatus capable of accessing two storages between which data transfer is performed. The information processing apparatus performs data transfer between storages by a program that carries out storage tiering. It is possible to roughly divide the data transfer between storages into data transfer for copying data from one storage to the other storage, and data transfer for relocating data from one storage to the other storage.

A transfer unit for performing data transfer between storages is a data unit, such as a logical unit number (LUN) or a sub-LUN. The amount of data of such data unit is specifically hundreds of giga bytes (GB), for example. In the case of performing data transfer of the above-described amount of data, an information processing apparatus divides data into blocks having a predetermined size, and performs data transfer for each divided data under an operating system (OS) that is running.

FIG. 1 is a diagram illustrating an example of data transfer executed under the control of an OS. As illustrated in FIG. 1, when transfer source data 1, which is a transfer unit specified as a transfer source, has a certain amount of data or more, the OS divides the transfer source data 1 into a plurality of divided data is each having a predetermined size, and performs data transfer for each divided data 1a. Accordingly, the OS causes the information processing apparatus to transmit a data transfer request for performing data transfer between storages to a target storage for each divided data 1a. By transmitting a data transfer request for each divided data 1a, it is possible to transmit another request (user request) that requests an access to the storage storing the transfer source data 1 until transmission of all the data transfer requests is completed.

In continuous issuing of requests, such as issuing of a request for each divided data 1a, a response from a storage to a previous request is normally waited, and then a next request to be issued is made. However, there is an exception.

For example, in a storage, such as a hard disk apparatus, the amount of head movement heavily influences an access speed. In such a storage, making the amount of head movement smaller results in an increase in the number of input/output (I/O) requests allowed to be processed per unit time. Accordingly, when a larger number of I/O requests, which are user requests for performing sequential access with small amount of head movement, are issued, or when a requested transmission destination storage has a high load (is busy), an OS gives priority to the issue of such I/O request (transmission (selection)) over the other I/O requests. As a result, a data transfer request to perform data transfer between storages is selected at certain intervals. Hereinafter the certain time period is expressed as “time-out time”.

FIG. 2 is a diagram illustrating an example of a graph indicating delay time from issue of an I/O request to reception of a response when a sequential access with higher load than usual occurs. The horizontal axis represents time (elapsed time from measurement start; the unit is second), and the vertical axis represents delay time (expressed as “I/O request delay” in FIG. 2; the unit is second). Each point represents a corresponding I/O request. The points representing data transfer requests for data transfer between storages are expressed by being enclosed with circles, respectively, in FIG. 2. Thus, all the other points that are not enclosed by a circle represent user requests.

Normally, an OS separates requests by a priority set for a type of the request, and preferentially selects a request having a higher priority. In the case of selecting a request by priority in that way, a request having a low priority is not selected in a circumstance that includes higher priority requests. Accordingly, it is a common practice that the OS temporarily changes the priority of a request to be selected at certain intervals, namely at time-out time intervals, and selects a low-priority request even in a circumstance that includes higher priority requests.

As is apparent that a data transfer request has a longer delay time than a user request has, a data transfer request that performs data transfer between storages is handled as a low priority request. Accordingly, a data transfer request that has been issued is selected by elapse of time-out time, and is issued to a storage. As a result, as illustrated in FIG. 2, each data transfer request is issued substantially at time-out intervals in sequence. A substantially same delay time for each data transfer request indicates that a delay time of each data transfer request is substantially the same as the time-out time.

FIG. 3 is a diagram illustrating an example of a relationship between data transfer size and delay time when a high-load sequential access occurs. The horizontal axis represents data transfer size, and the vertical axis represents delay time (expressed as “response” in FIG. 3). Here, the delay time is a time period from when a request of data transfer is made to an OS to when a response indicating the completion of the data transfer is received from a storage. A line 31 represents a relationship between data transfer size and delay time for the case of a user request, and a line 32 represents a relationship between data transfer size and delay time for the case of a data transfer request.

In data transfer by a user request, as illustrated by the line 31, delay time for the data transfer becomes exponentially long in accordance with data transfer size. On the other hand, as illustrated in FIG. 2, delay time regarding a data transfer request includes time-out time. Accordingly, as illustrated by the line 32, delay time becomes long in a stepwise manner in accordance with data transfer size. If it is assumed that delay time of one data transfer request is equal to time-out time, delay time becomes time produced by multiplying the number of divisions of transfer source data 1 by time-out time (=the number of divisions×time-out time).

An access to the transfer source data 1 to be transferred becomes possible when the data transfer is complete. That is to say, an access to the transfer source data 1 is prohibited during a time period in accordance with the number of divisions of the transfer source data 1. Data transfer between storages is performed in order to move data that is normally used or data having a high possibility of being used to a higher-speed storage. This means that there is a high possibility that a user request for accessing at least part of the transfer source data 1 occurs before the completion of data transfer of the transfer source data 1. Accordingly, in order to realize efficient data processing, it seems important to allow access to part of data to be transferred before completion of data transfer between storages.

Related-art techniques have been disclosed in Japanese Laid-open Patent Publication Nos. 2003-216460 and 2011-165164.

### SUMMARY

According to an aspect of the invention, an apparatus connected to first and second storages performs data transfer between the first and second storages for a plurality of times with different data sizes, and measures a transfer time defined as a transfer interval time for data transfer of each of the plurality of times. The apparatus identifies a maximum size data indicating a maximum data size for data transfer between the first and second storages, based on the transfer time and the data size for data transfer of each of the plurality of times. When data transfer is performed between the first and second storages, the apparatus divides transfer target data for the data transfer into plural pieces of divided data, based on the maximum size data, and outputs, for each of the plural pieces of divided data, a data transfer request for requesting the apparatus to perform data transfer between the first and second storages.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of data transfer executed under the control of an OS;

FIG. 2 is a graph indicating an example of delay time from issue of an I/O request to reception of a response when a sequential access with higher load than usual occurs;

FIG. 3 is an explanatory diagram of a relationship between a data transfer size and delay time when a high-load sequential access occurs;

FIG. 4 is a diagram illustrating an example of a configuration of a hierarchical storage system built using an information processing apparatus according to an embodiment;

FIG. 5 is a diagram illustrating an example of variables used for a data-size determination unit to identify a data-size value, according to an embodiment;

FIG. 6 is a diagram illustrating an example of a method for identifying the data-size value by the data-size determination unit, according to an embodiment;

FIG. 7 is a diagram illustrating an example of an operational flowchart for data-size determination processing, according to an embodiment;

FIG. 8 is a diagram illustrating an example of a configuration of the information processing apparatus that is usable as a server, according to an embodiment; and

FIG. 9 is a diagram illustrating an example of an operational flowchart for data-size determination processing, according to an embodiment.

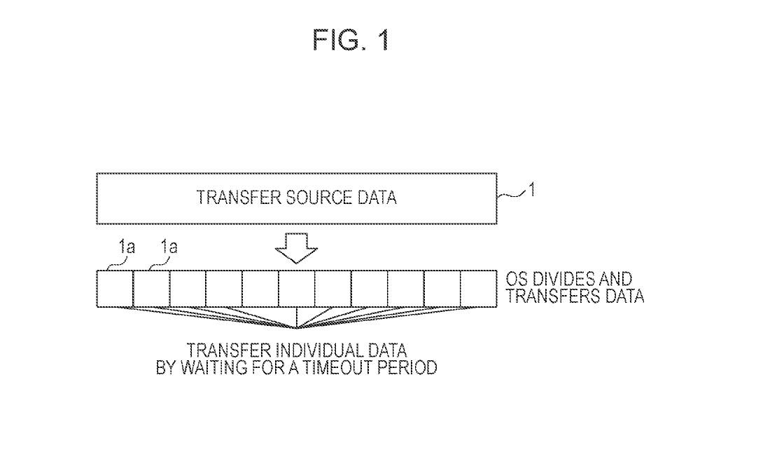

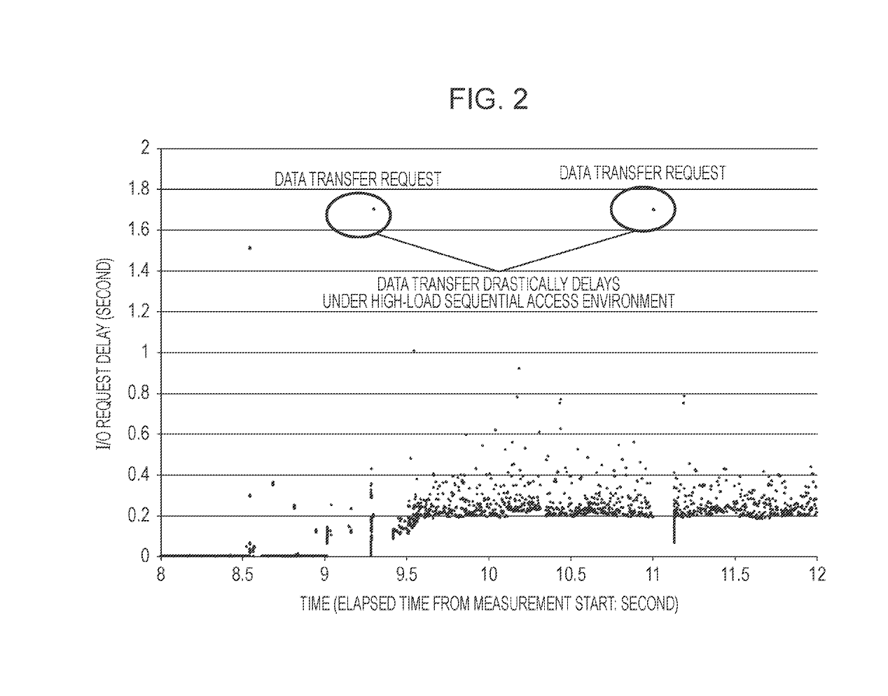

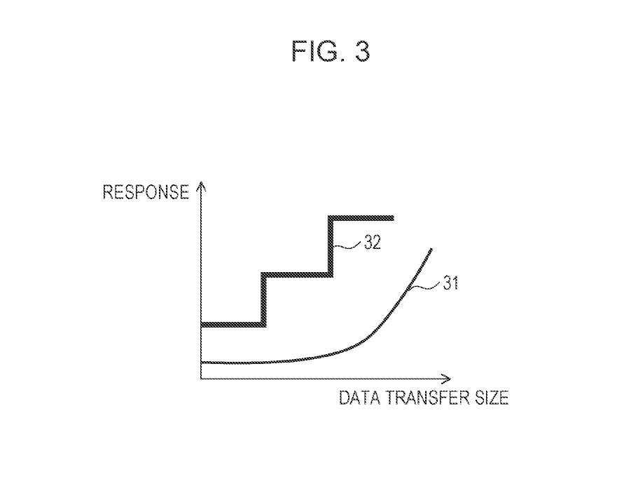

### DESCRIPTION OF EMBODIMENTS

In the following, a detailed description is given of embodiments of the present disclosure with reference to the drawings.

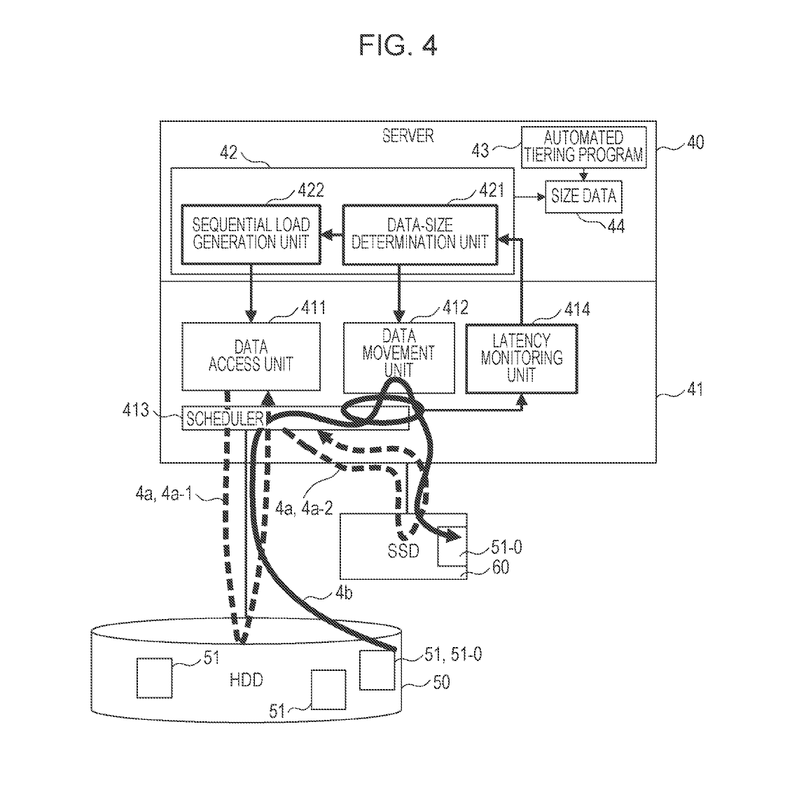

FIG. 4 is a diagram illustrating an example of a configuration of a hierarchical storage system built using an information processing apparatus according to an embodiment. As illustrated in FIG. 4, the hierarchical storage system includes a server 40, which is an information processing apparatus according to the embodiment, a hard disk apparatus (HDD) 50, which is a low-speed storage, and an solid state drive (SSD) 60, which is a high-speed storage.

In FIG. 4, as an explanation, only one hard disk apparatus 50 and one SSD 60 are individually illustrated for the sake of convenience. However, in many cases, a plurality of hard disk apparatuses 50 and a plurality of SSDs 60 are provided. Also, tiered storage is realized by employing the hard disk apparatus 50 and the SSD 60 as two kinds of storages having different access speeds. However, the storages to be employed are not limited to this combination. The number of tiers is not limited to two. That is to say, the number of tiers may be three or more.

In FIG. 4, as programs running on the server 40, only an OS 41, a transfer setting program 42, and an automated tiering program 43 are illustrated.

The OS 41 is a program that actually performs data transfer between the hard disk apparatus 50 and the SSD 60. The transfer setting program 42 is an application program (hereinafter abbreviated as an “application”) provided for optimization of data transfer.

The automated tiering program 43 is an application that realizes automated tiering of storages in cooperation with the OS 41, and controls data transfer between the hard disk apparatus 50 and the SSD 60. Here, it is assumed that the automated tiering program 43 detects a data access frequency, and performs data transfer for relocation of data in accordance with the detected access frequency.

Each data 51 in the hard disk apparatus 50 is a transfer unit of data. The data 51 has a size for which the OS 41 performs dividing and transfers a plurality of divided data, and is transferred to the SSD 60 as occasion arises. Out of the pieces of data 51 stored in the SSD 60, the data 51 to be relocated is transferred from the SSD 60 to the hard disk apparatus 50. The data transfer is performed under the control of the automated tiering program 43.

The OS 41 realizes a data access unit 411, a data movement unit 412, a scheduler 413, and a latency monitoring unit 414 as functions.

The data access unit 411 has a function of issuing a user request by a request from an application running on the OS 41. Arrows 4a (4a-1 and 4a-2) denoted by two dotted lines in FIG. 4 indicate that a user request is transmitted to the hard disk apparatus 50 or the SSD 60, and a response is returned to the data access unit 411 by the transmission.

The data movement unit 412 has a function of realizing data transfer between the hard disk apparatus 50 and the SSD 60, and issues a data transfer request in order to perform the data transfer. An arrow 4b denoted by a solid line in FIG. 4 indicates a transfer path when data transfer is performed in order to move data 51-0 stored in the hard disk apparatus 50 to the SSD 60 through the data movement unit 412.

The scheduler 413 has a function of inputting requests issued from the data access unit 411 and the data movement unit 412, and selects one from the input requests to transmit the selected request to the storage to which the request is to be transmitted.

A request issued by the data access unit 411 and a request issued by the data movement unit 412 have different priorities. The request issued by the data access unit 411 has a high priority, and the request issued by the data movement unit 412 has a low priority. In a state in which there is a request issued by the data access unit 411, the scheduler 413 selects a request issued by the data movement unit 412 for each elapse of time-out time.

The latency monitoring unit 414 has a function added in cooperation with the transfer setting program 42, and measures transfer time (delay time) that is desired for processing all the data transfer requests issued from the data movement unit 412. The transfer time is a time period from when a first data transfer request is output to the scheduler 413 to when the data movement unit 412 receives input of a response of the hard disk apparatus 50 with respect to a last data transfer request. Hereinafter, this transfer time is also called “response time”.

The transfer setting program 42 sets a data size with which one data transfer is to be performed when data transfer (relocation) between storages is performed. A size data 44 illustrated in FIG. 4 is data indicating the set (stored) data-size value. The size data 44 is set in order to make it possible to perform more efficient data processing while carrying out data transfer efficiently. The information processing apparatus that performs data processing may be the server 40, but may be an information processing apparatus that receives data from the server 40.

In order to allow accessing a part of the transfer unit data 51, the transfer of which has been completed, the automated tiering program 43 divides the data 51 to be relocated, based on the size data 44, and performs data transfer for each divided data. It is desirable that the size of divided data (hereinafter expressed as a “divided data size”) matches a size of data that is to be transferred once by the data movement unit 412 (hereinafter expressed as a “maximum transfer size”). This is because if the divided data size does not match the maximum transfer size, it is highly likely that a larger number of data transfer requests are actually issued.

When the divided data size is less than the maximum transfer size, the following relationship holds: ceil (the size of data 51/the divided data size) ceil (the size of data 51/the maximum transfer size), where the “ceil” is a function representing an integer produced by rounding up decimal places of the argument.

Normally, the maximum transfer size is greatly different from the size of data 51. Accordingly, unless the difference between the divided data size and the maximum transfer size is very small, the following relationship holds: ceil (the size of data 51/the divided data size)>ceil (the size of data 51/the maximum transfer size). Thus, when the divided data size is smaller than the maximum transfer size, the number of data transfer requests to be issued is commonly larger compared with the case of performing data transfer by the maximum transfer size.

On the other hand, when the divided data size is larger than the maximum transfer size, a plurality of data transfer requests are desired to be issued in order to transfer a piece of data of the divided data size. Accordingly, compared with performing data transfer by the maximum transfer size, the number of data transfer requests to be issued becomes large without exception.

An increase in the number of data transfer requests to be issued means that data transfer efficiency decreases. With the decrease of the data transfer efficiency, the transfer time desired for data transfer (relocation) of the entire data 51 becomes longer. Also, as the transfer time becomes longer, the possibility of

transmitting requests to the hard disk apparatus 50 becomes high because of the accessing a part of the data 51 that has not been moved to the SSD 60.

Accordingly, a decrease in the data transfer efficiency is not desirable in order to realize more efficient data processing. As a result, in the embodiment, a divided data size that is regarded as identical to a maximum transfer size is set as the data size 44 in order to realize higher data transfer efficiency and more efficient data processing.

In order to set the data size 44, as illustrated in FIG. 4, the transfer setting program 42 includes a data-size determination unit 421, and a sequential load generation unit 422 as functions.

The sequential load generation unit 422 has a function of causing the data access unit 411 to issue a user request in accordance with an instruction from the data-size determination unit 421. The user request to be issued is a sequential access request that makes a sequential access to an adjacent area in the hard disk included in the hard disk apparatus 50. The user request is issued in order for the scheduler 413 to select a data transfer request issued from the data movement unit 412 at time-out intervals.

The data-size determination unit 421 has a function of identifying a divided data-size value to be set as the size data 44. The data-size determination unit 421 causes the data movement unit 412 to issue a data transfer request having a changed divided data-size value under the circumstances in which the sequential load generation unit 422 causes the data access unit 411 to issue a request for a sequential access. Thereby, the data-size determination unit 421 identifies a divided data-size value to be set as the data size 44 from a relationship between the divided data size and the transfer time measured by the latency monitoring unit 414.

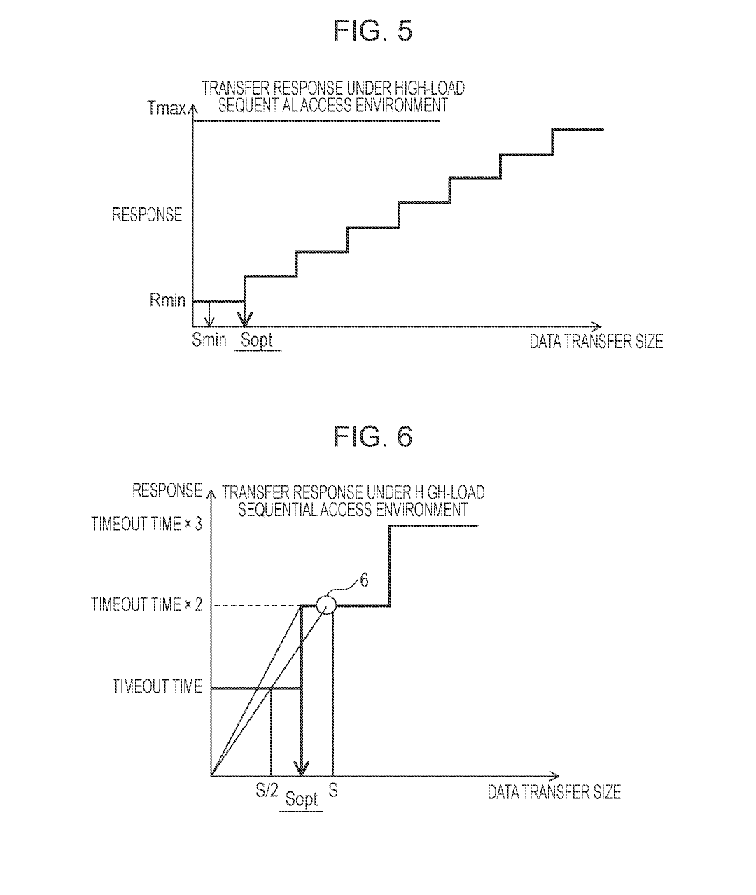

FIG. 5 is a diagram illustrating an example of variables used for a data-size determination unit to identify a data-size value, according to an embodiment. FIG. 6 is a diagram illustrating an example of a method for identifying the data-size value by the data-size determination unit, according to an embodiment. Here, a specific description is given of operation related to setting the data size 44 by the data size determination unit 421 with reference to FIG. 5 and FIG. 6.

In both of the graphs illustrated in FIG. 5 and FIG. 6, the horizontal axis represents data transfer size, and the vertical axis represents transfer time (expressed as “response” in both FIG. 5 and FIG. 6). As illustrated in FIG. 5 and FIG. 6, the transfer time changes in a staircase pattern in accordance with the data transfer size.

In FIG. 5, “Tmax”, “Rmin”, “Smin”, and “Sopt” are expressed as an example of variables. In FIG. 6, “S” is expressed as an example of a variable. These variables are used as follows.

“Tmax” is a variable to which maximum time that is permissible as transfer time (hereinafter, expressed as a “maximum permissible transfer time”) is assigned. “Rmin” is a variable to which a minimum transfer time is assigned out of transfer times the latency monitoring unit 414 actually measured. The transfer time measured finally at the time of transferring data of a maximum transfer size or less is assigned to the variable Rmin.

“Smin” is a variable to which a data-size value set as a minimum divided data-size value in advance is assigned. “Sopt” is a variable to which a value to be set to the data size 44, that is to say, an optimum divided data size value is assigned. “S” is a variable to which a value expressing the data size of data transferred by the data transfer request issued by the data movement unit 412 is assigned.

In the embodiment, a value to be assigned to the variable Sopt is identified by focusing attention on the fact that transfer time changes in a staircase pattern in accordance with a data transfer size and the fact that the data-size value is usually a value of a power of 2. Accordingly, in the embodiment, it is assumed that a maximum transfer size value is a power of 2, and two kinds of transfer time, a minimum transfer time and the other transfer time are identified.

The other transfer time becomes about N times the minimum transfer time (N is an integer more than 1). If it is assumed that a data-size value when the other transfer time has been measured is S, a value to be assigned to the variable Sopt, that is to say, the maximum transfer size value becomes as follows: S/N Sopt<S/N×2. Accordingly, when the maximum transfer size value is a power of 2, the maximum transfer size value becomes a value that is a minimum power of 2 not less than S/N. In order to avoid confusion, hereinafter, it is assumed that the transfer time completely match an integer multiple of time-out time, and variations of the transfer time to be measured are disregarded.

FIG. 6 illustrates the case where the value of N is 2. In this case, a point 6 in FIG. 6 indicates that the transfer time measured when the data-size value is S is two times the time-out time. The maximum transfer size value to be assigned to the variable Sopt becomes a value that is a minimum power of 2 existing in the range of S/2≦Sopt<S.

In order to change the transfer time in a staircase pattern in accordance with the data transfer size, it is requested that data transfer is performed in an environment in which user requests exist all the time. Accordingly, in the embodiment, the sequential load generation unit 422 causes user requests for a sequential access to be issued.

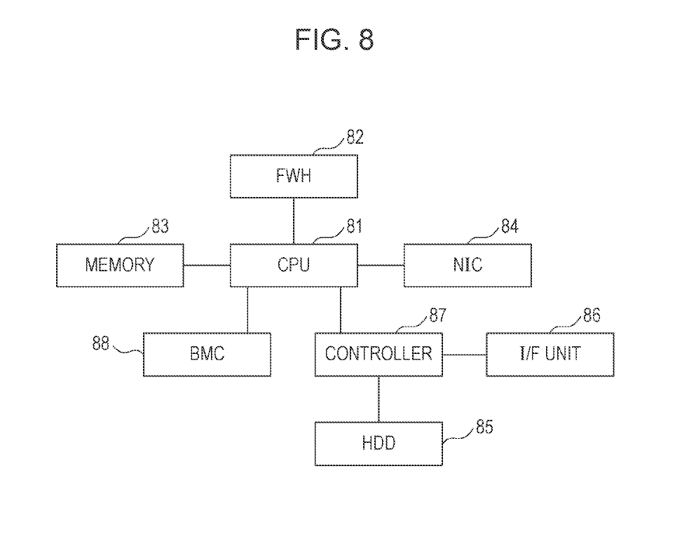

The server 40 executing the transfer setting program 42 including the data-size determination unit 421 and the sequential load generation unit 422 has a hardware configuration as illustrated in FIG. 8, for example. Here, with reference to FIG. 8, a specific description is given of an example of a configuration of an information processing apparatus that is allowed to be used as the server 40 in the embodiment.

As illustrated in FIG. 8, the information processing apparatus includes a central processing unit (CPU) 81, a firmware hub (FWH) 82, a memory (memory module) 83, a network interface card (NIC) 84, a hard disk apparatus (HD) 85, an interface (I/F) unit 86, a controller 87, and a baseboard management controller (BMC) 88. This configuration is one example of an information processing apparatus used as a server 40. The configuration of an information processing apparatus that is allowed to be used as an information processing apparatus according to the embodiment is not limited to the configuration illustrated in FIG. 8.

The FWH 82 is a memory that stores a firmware. This firmware is read into the memory 83, and executed by the CPU 81. The hard disk apparatus 85 stores various programs including the OS 41 and the transfer setting program 42. The CPU 81 is configured to read, after completion of starting the firmware, various programs including the OS 41 and the transfer setting program 42 from the hard disk apparatus 85 to the memory 83 through the controller 87 to execute the programs. The communication through the NIC 84 becomes possible by starting the firmware or the OS 41.

The I/F unit 86 is configured to communicate with a plurality of storages. It is possible to connect the hard disk apparatus 50 and the SSD 60, illustrated in FIG. 4, with the I/F unit 86. The communication through the I/F unit 86 becomes possible by starting the firmware, for example.

The NIC 84 allows communication through a network, such as a local area network (LAN), and so on. The NIC 84 may connect the hard disk apparatus 50 and the SSD 60, illustrated in FIG. 4, to a network through which communication is possible.

The BMC 88 is a dedicated management apparatus for managing the information processing apparatus. The BMC 88 performs on/off control of the CPU 81, monitoring of an error that occurs in each component, and so on.

The OS 41 and the transfer setting program 42 illustrated in FIG. 4 are read from the hard disk apparatus 85 to the memory 83 through the controller 87 which are executed by the CPU 81. The CPU 81 accesses the hard disk apparatus 85 through the controller 87 after starting execution of the firmware read from the FWH 82. Thereby, all the functions provided for each of the OS 41 and the transfer setting program 42 are realized by the CPU 81, the FWH 82, the memory 83, the controller 87, and the hard disk apparatus 85, for example. The size data 44 is normally stored in the memory 83.

The server 40 as an information processing apparatus according to the embodiment is realized by the CPU 81 executing the OS 41 and the transfer setting program 42. The server 40 as an information processing apparatus according to the embodiment is realized by the CPU 81 at least executing the OS 41 and the automated tiering program 43. The server 40 as an information processing apparatus according to the embodiment is configured so that the CPU 81 executes the transfer setting program 42 in addition to the OS 41 and the automated tiering program 43.

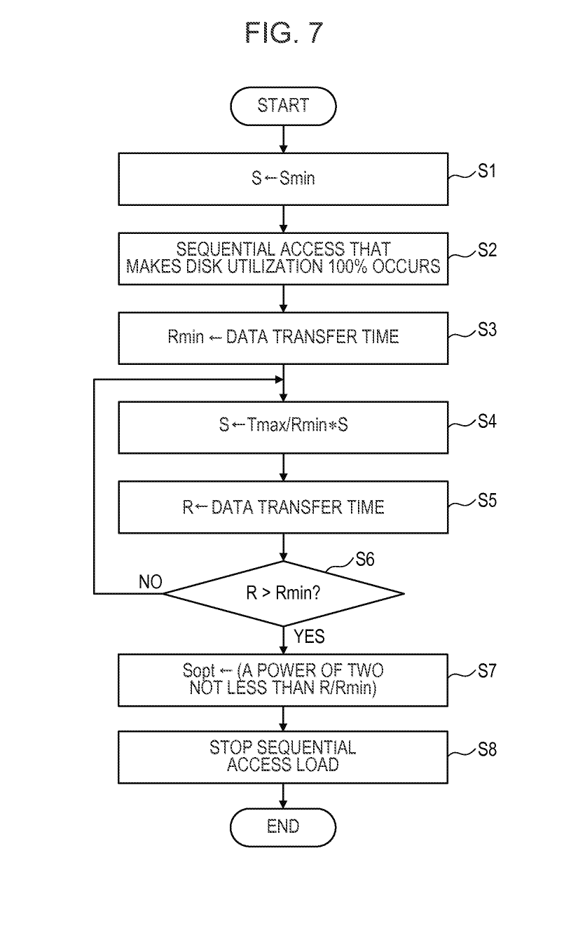

FIG. 7 is a diagram illustrating an example of an operational flowchart for data-size determination processing, according to an embodiment. The data-size determination processing is processing realized by the CPU 81 executing the transfer setting program 42. The data-size determination unit 421 is realized by executing the data-size determination processing. The transfer setting program 42 is executed, for example, at starting time or by an instruction of an operator. Next, a detailed description is given of the data-size determination processing with reference to FIG. 7.

The CPU 81 is configured to execute all the programs including the transfer setting program 42 and the OS 41. Thereby, if it is assumed that the main body for executing the processing is the CPU 81, the program (including a sub-program here) executed by the CPU 81 becomes indistinct. Accordingly, here, a description is given using names of the functions that are individually included in the OS 41 and the transfer setting program 42.

First, the data-size determination unit 421 assigns, to the variable S, a value of the variable Smin, that is to say, a minimum divided data-size value (S1). Next, the data-size determination unit 421 generates user requests for a sequential access that makes the utilization of the hard disk apparatus 50 (expressed as “DISK” in FIG. 7) 100%, through the sequential access load generation unit 422 (S2). After that, the data-size determination unit 421 requests the data movement unit 412 of the OS 41 to transfer data using the value of the variable S as the data-size value, obtains the data transfer time measured by the latency monitoring unit 414, and assigns the obtained data transfer time to the variable Rmin (S3).

At this time, the data transfer time measured by the latency monitoring unit 414 is time from when the data movement unit 412 issued a data transfer request to the scheduler 413 to time when a response from the hard disk apparatus 50 to which the data request has been transmitted is received. The data in the hard disk apparatus 50 to be requested for transfer may be any data, but it is requested that an area on the SSD 60 to store the transfer data is an unused area or an area storing needless data.

The data-size determination unit 421 that has assigned the data transfer time to the variable Rmin updates the value of the variable S (S4). The update is performed by newly assigning a value obtained by the product of the value of the variable Tmax divided by the value of the variable Rmin and the value of the current variable S (=Tmax/Rmin*S) to the variable S. The maximum permissible transfer time indicated by the value assigned to the variable Tmax is set to a very long time period compared with the data transfer time (minimum transfer time) indicated by the value assigned to the variable Rmin. Accordingly, the value that is newly assigned to the variable S becomes a very large value compared with the value of the variable S up to that time.

After updating the value of the variable S, the data-size determination unit 421 makes a request of data transfer to the data movement unit 412 of the OS 41 with the value of variable S being set to the data-size value, obtains the data transfer time measured by the latency monitoring unit 414, and assigns the obtained data transfer time to the variable R (S5). Next, the data-size determination unit 421 determines whether the value of the variable R is greater than the value of the variable Rmin (S6). When the value of the variable R is greater than the value of the variable Rmin by a predetermined value or more, that is to say, when the difference between the value of the variable R and the value of the variable Rmin is regarded as one time-out time or more, the determination of S6 becomes Yes, and the processing proceeds to S7. When the value of the variable R is not greater than the value of the variable Rmin by a predetermined value or more, the determination of S6 becomes No, and the processing returns to S4.

In S7, the data-size determination unit 421 assigns a minimum power of 2 which is greater than the value of the variable R divided by the value of the variable Rmin to the variable Sopt, and stores the value of the variable Sopt as the size data 44. After storing the value, the data-size determination unit 421 instructs the sequential load generation unit 422 to stop operation of causing user requests for a sequential access to be issued (S8). After that, the data-size determination processing is terminated. By the termination of the data-size determination processing, the data-size determination unit 421 is stopped.

As described above, when the maximum transfer size value is a power of two, it is possible to identify the maximum transfer size value properly by measuring the data transfer time two times. Accordingly, compared with a method for identifying a maximum transfer size value by changing the data-size value (the value of the variable S) in sequence, it is possible to identify the maximum transfer size value significantly promptly.

The automated tiering program 43 performs data transfer between the hard disk apparatus 50 and the SSD 60 with reference to the size data 44 stored by the execution of the data-size determination processing. The automated tiering program 43 divides the data 51 to be transferred, which is stored in the hard disk apparatus 50 or the SSD 60, by the data-size value indicated by the size data 44, and instructs the OS 41 to perform data transfer for each divided data. Thereby, the data 51 to be transferred is subjected to data transfer in which access to only a part of the data 51 is prohibited.

### Another Embodiment

In the above-described embodiment, the data-size value to be the maximum transfer size value is identified by assuming that the maximum transfer size value by which the OS 41 performs data transfer is a power of two. However, it is thought that the maximum transfer size value might not be a power of two. In the other embodiment, the data-size value that is considered to be the maximum transfer size value is identified by assuming that the maximum transfer size value is not a power of two.

The configuration of the server (information processing apparatus) in the other embodiment may be the same as that in the above-described embodiment. The program to be executed is basically the same as that of the above-described embodiment. Thus, a description is given of only parts that are different from the above-described embodiment using the symbols of the above-described embodiment.

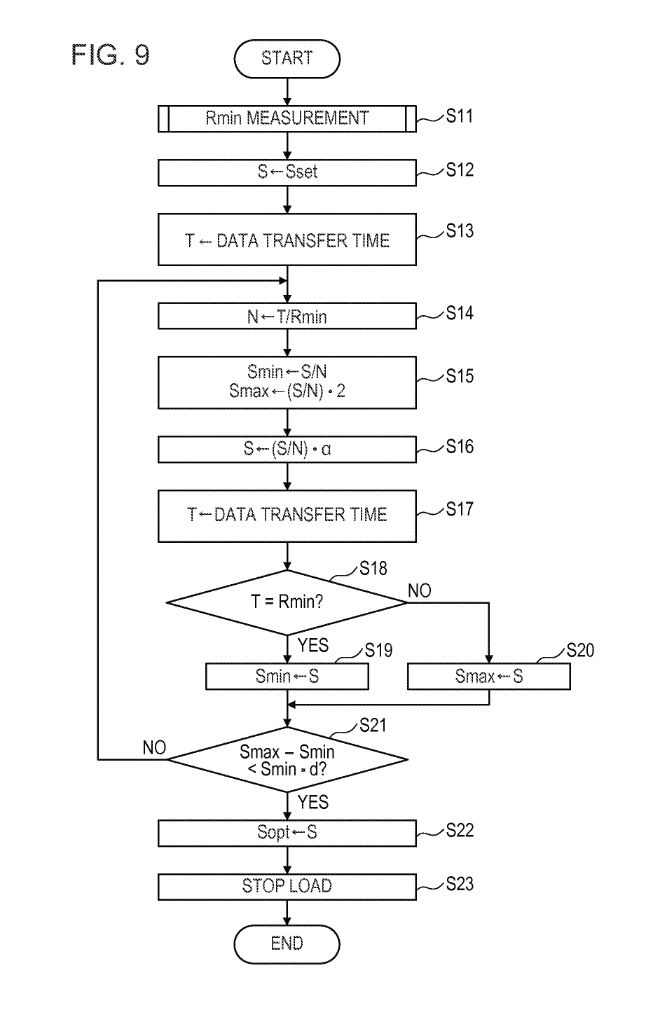

In the other embodiment, the data-size determination unit 421 is different from that of the above-described embodiment. The data-size determination unit 421 in the other embodiment is realized by executing the data-size determination processing illustrated in FIG. 9. Thus, a detailed description is given of the data-size determination processing in the other embodiment with reference to FIG. 9. Here, a main body that executes processing is assumed to be functions included in the OS 41 and the transfer setting program 42.

First, the data-size determination unit 421 measures the data transfer time to be assigned to the value of the variable Rmin, and performs Rmin measurement processing for assigning the value indicating the measured data transfer time to the variable Rmin (S11). For the Rmin measurement processing, for example, the processing of S1 to S3 in FIG. 7 may be performed.

Next, the data-size determination unit 421 assigns the value of the variable Sset to the variable S (S12). The value of the variable Sset is a value to be at least two times the maximum transfer size value or more. For example, it is possible to calculate the value in the same method as that of S4 in FIG. 7. After that, the data-size determination unit 421 requests the data movement unit 412 of the OS 41 to perform data transfer with the value of the variable S being set to the data-size value, obtains the data transfer time measured by the latency monitoring unit 414, and assigns the obtained data transfer time to the variable T (S13).

The data-size determination unit 421, which has assigned the data transfer time to the variable T, assigns the quotient value when the value of the variable T is divided by the value of the variable Rmin to the variable N (S14). Next, the data-size determination unit 421 assigns a division result (=S/N) produced by dividing the value of the variable S by the value of the variable N to the variable Smin, and assigns two times the division result value to the variable Smax (S15).

The data-size determination unit 421, which has assigned values to the variables Smin and Smax, respectively, assigns the product of the division result obtained by dividing the value until that moment by the value of the variable N and a predetermined value α to the variable S (=(S/N)·α). The predetermined value α is a value set in order to calculate the data-size value for confirming the data transfer time, within the range between the value of the variable Smin and the value of the variable Smax. Accordingly, the predetermined value α has a relationship as follows: 1<α<2. The data-size determination unit 421, which has updated the value of the variable S, makes a request of data transfer to the data movement unit 412 of the OS 41 with the data-size value being set to the value of the updated variable S, obtains the data transfer time measured by the latency monitoring unit 414, and assigns the obtained data transfer time to the variable T (S17).

Next, the data-size determination unit 421 determines whether the value of the variable T is equal to the value of the variable Rmin (S18). When the value of the variable T is not equal to the value of the variable Rmin, that is to say, when the value of the variable T is greater than the value of the variable Rmin, the determination of S18 becomes No, and the processing proceeds to S20. when the value of the variable T is equal to the value of the variable Rmin, the determination of S18 becomes Yes, and the processing proceeds to S19.

In S19, the data-size determination unit 421 assigns the value of the variable S to the variable Smin. After that, the processing proceeds to S21. On the other hand, in S20, the data-size determination unit 421 assigns the value of the variable S to the variable Smax. After that, the processing proceeds to S21.

In S21, the data-size determination unit 421 determines whether the result when the value of the variable Smin is subtracted from the value of the variable Smax is less than the result when the value of the variable Smin is multiplied by a predetermined value d. The predetermined value d is a value set in order to determine whether the subtraction result is sufficiently small or not. Thus, when the subtraction result is regarded as a sufficiently small value, the determination of S21 becomes Yes, and the processing proceeds to S22. When the subtraction result is not regarded as a sufficiently small value, the determination of S21 becomes No, and the processing returns to S14.

In S22, the data-size determination unit 421 assigns the value of the variable S to the variable Sopt, and stores the value of the variable Sopt as the size data 44. After storing the value, the data-size determination unit 421 instructs the sequential load generation unit 422 to stop operation that causes user requests for a sequential access to be issued (S23). After that, the data-size determination processing is terminated. By the termination of the data-size determination processing, the data-size determination unit 421 stops.

When the processing returns to S14 because the determination of S21 is No, another value is assigned to the variable S in S16. Thereby, the processing loop from S14 to S21 is repeatedly executed while changing the value of the variable S until when the determination of S21 becomes Yes. A method for identifying a maximum transfer size value in the case where the maximum transfer size value is not assumed to be a power of two is not limited to the above-described method. Another method may be employed.

In this regard, in each of the above-described embodiments, the server 40 as an information processing apparatus may be an information processing apparatus other than an information processing apparatus that performs data transfer between storages. That is to say, the information processing apparatus may not perform data transfer between storages.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus connected to first and second storages, the apparatus comprising:
a timer unit configured:
to perform data transfer between the first and second storages for a plurality of times with different data sizes, and
to measure a transfer time defined as a transfer interval time for data transfer of each of the plurality of times;
an identification unit configured to identify a maximum size data indicating a maximum data size for data transfer between the first and second storages, based on the transfer time and the data size for data transfer of each of the plurality of times;
a storage unit configured to store the maximum size data identified by the identification unit;
a requesting unit configured:
to divide, when data transfer is performed between the first and second storages, transfer target data for the data transfer into plural pieces of divided data, based on the maximum size data stored in the storage unit, and
to output a first data transfer request for each of the plural pieces of divided data; and
a movement unit configured to perform data transfer between the first and second storages, based on the first data transfer request output by the requesting unit.

2. The apparatus of claim 1, wherein
the timer unit is configured to measure the transfer time when the requesting unit is making, for one of the first and second storages, a second data transfer request having a higher priority than the first data transfer request to the movement unit.

3. A system comprising:
a first storage;
a second storage; and
an information processing apparatus connected to the first and second storages, wherein
the information processing apparatus includes:
a timer unit configured:
to perform data transfer between the first and second storages for a plurality of times with different data sizes, and
to measure a transfer time defined as a transfer interval time for data transfer of each of the plurality of times;
an identification unit configured to identify a maximum size data indicating a maximum data size for data transfer between the first and second storages, based on the transfer time and the data size for data transfer of each of the plurality of times;
a storage unit configured to store the maximum size data identified by the identification unit;
a requesting unit configured:
to, when data transfer is performed between the first and second storages, divide transfer target data for the data transfer into a plural pieces of divided data, based on the maximum size data stored in the storage unit, and
to output a first data transfer request for each of the plural pieces of divided data; and
a movement unit configured to perform data transfer between the first and second storages, based on the first data transfer request output by the requesting unit.

4. A method for controlling an information processing apparatus connected to first and second storages, the method comprising:
causing a timer unit included in the information processing apparatus:
to perform data transfer between the first and second storages for a plurality of times with different data sizes, and
to measure a transfer time defined as a transfer interval time for data transfer of each of the plurality of times;
causing an identification unit included in the information processing apparatus to identify a maximum size data indicating a maximum data size for data transfer between the first and second storages, based on the transfer time and the data size for data transfer of each of the plurality of times;
causing a requesting unit included in the information processing apparatus:
to divide, when data transfer is performed between the first and second storages, transfer target data for the data transfer into a plural pieces of divided data, based on the maximum size data stored in the storage unit, and
to output a first data transfer request for each of the plural pieces of divided data; and
causing a movement unit included in the information processing apparatus to perform data transfer between the first and second storages, based on the first data transfer request output by the requesting unit.

5. A non-transitory, computer-readable recording medium having stored therein a program for causing an information processing apparatus connected to first and second storages to execute a process comprising:
causing a timer unit included in the information processing apparatus:
to perform data transfer between the first and second storages for a plurality of times with different data sizes, and
to measure a transfer time defined as a transfer interval time for data transfer of each of the plurality of times;
causing an identification unit included in the information processing apparatus to identify a maximum size data indicating a maximum data size for data transfer between the first and second storages, based on the transfer time and the data size for data transfer of each of the plurality of times;
causing a requesting unit included in the information processing apparatus:
to divide, when data transfer is performed between the first and second storages, transfer target data for the data transfer into a plural pieces of divided data, based on the maximum size data stored in the storage unit, and
to output a first data transfer request for each of the plural pieces of divided data; and
causing a movement unit included in the information processing apparatus to perform data transfer between the first and second storages, based on the first data transfer request output by the requesting unit.
